(19) United States
(12) Patent Application Publication
(10) Pub. No.: US 2002/0065860 A1
(43) Pub. Date: May 30, 2002

(54) Data processing apparatus and method for saturating data values

(76) Inventors: Richard Roy Grisenthwaite, Guilden Morden (GB); Dominic Hugo Symes, Cambridge (GB); David James Seal, Cambridge (GB)

Correspondence Address: NIXON & VANDERHYE P.C., 1100 North Glebe Road, 8th Floor, Arlington, VA, 22201, US

(21) Appl. No.: 09/957,467

(22) Filed: Sep. 20, 2001

(30) Foreign Application Priority Data
Oct. 4, 2000 (GB) 0024311.3
Oct. 4, 2000 (GB) 0024312.1
Dec. 14, 2000 (GB) 0030533.4

(51) Int. Cl. G06F 7/00

(52) U.S. Cl. 708/207

(57) ABSTRACT

The present invention relates to a data processing apparatus and method for saturating data values. The data processing apparatus comprises a data processing unit for executing instructions, the data processing unit being responsive to a saturation instruction to apply a saturation operation to a data word Rm comprising a plurality of data values. The saturation operation yields a value given by: determining from data provided within a field of the saturation instruction a bit position to which saturation is to take place, and performing in parallel an independent saturation operation on each of the data values to saturate each of the data values to the determined bit position to form a result data word Rd comprising a plurality of saturated data values. This techniques provides a particularly efficient and flexible technique for saturating multiple data values.

### BACKGROUND OF THE INVENTION

1. Field of the Invention

The present invention relates to a data processing apparatus and method for saturating data values.

2. Description of the Prior Art

When performing data processing operations, there are many instances where it is required to saturate a data value to an n-bit value, where the original data value typically comprises more than n-bits. For a signed data value x, the saturation operation will typically produce the following signed saturated data value x_{OUT} dependent on the value of x:

| | |
|---|---|
| If x < −2ⁿ⁻¹ | x_{OUT} = −2ⁿ⁻¹ |
| If −2ⁿ⁻¹ ≦x≦2ⁿ⁻¹ −1 | x_{OUT} = x |
| If x > 2ⁿ⁻¹ −1 | x_{OUT} = 2ⁿ⁻¹ −1 |

Similarly, if x_{OUT} is to be an unsigned data value, saturation will produce the following result for the unsigned saturated data value x_{OUT}:

| | |
|---|---|
| If x < 0 | x_{OUT} = 0 |
| If 0 ≦x≦2ⁿ −1 | x_{OUT} = x |
| If x > 2ⁿ −1 | x_{OUT} = 2ⁿ −1 |

An example of an application where saturation of data values is required is when performing the motion compensation part of an MPEG decode operation, as defined by the MPEG-4 standard. After the Inverse Discrete Cosine Transform (IDCT) operation, a 16-bit difference value is produced, which must be saturated to a 9-bit signed value and then added to an 8-bit unsigned value representing the motion estimated value of the pixel. The result of that addition must then be saturated to an 8-bit unsigned value representing the pixel value of the new frame.

Typical known saturate instructions are arranged to perform saturation to a fixed bit position, and hence typically a first saturate instruction may be provided to produce the saturation to a 9-bit signed value in accordance with the above example, with a second saturation instruction then being developed to perform the saturation to an 8-bit unsigned value.

It would be desirable to provide a saturation instruction which provides more flexibility as to the bit position to which saturation is performed and which enables the efficiency of the saturation operation to be improved.

### SUMMARY OF THE INVENTION

Viewed from a first aspect, the present invention provides a data processing apparatus, comprising: a data processing unit for executing instructions; the data processing unit being responsive to a saturation instruction to apply a saturation operation to a data word Rm comprising a plurality of data values, wherein said saturation operation yields a value given by: determining from data provided within a field of the saturation instruction a bit position to which saturation is to take place; and performing in parallel an independent saturation operation on each of the data values to saturate each of the data values to the determined bit position to form a result data word Rd comprising a plurality of saturated data values.

In accordance with the present invention, a data processing unit within a data processing apparatus is arranged to be responsive to a saturation instruction to apply a saturation operation to a data word Rm comprising a plurality of data values. Data provided within a field of the saturation instruction is then used to determine a bit position to which saturation is to take place, this enabling the same saturation instruction to be used to perform saturation to an arbitrary bit position, where in any particular instance, the bit position to which saturation is to take place is identified within the instruction itself. Then, in accordance with the present invention, the saturation instruction performs a saturation operation which yields a value given by performing in parallel an independent saturation operation on each of the data values within the data word Rm to saturate each of the data values to the determined bit position to form a result data word Rd comprising a plurality of saturated data values.

Hence, the saturation instruction used in accordance with the present invention enables flexibility in the choice of bit position to which saturation is to take place, and causes a plurality of data values to be saturated in parallel, thereby significantly increasing the efficiency and flexibility of the saturation process.

The invention takes advantage of the fact that there are many applications, for example many digital signal processing (DSP) applications, that require a smaller dynamic range of numbers than are often supported within a data processing apparatus, for example a microprocessor. As an example, a microprocessor may typically be arranged to apply operations to 32-bit data words, or even 64-bit data words, whereas typical DSP applications may only require use of numbers of 16-bits or less. In accordance with the present invention, a number of individual data values are hence provided within a single data word, with the saturation instruction then being arranged to independently saturate the data values within that data word.

Hence, in effect, the invention provides a novel single instruction multiple data type operation to enable multiple data values to be saturated in parallel via a single saturation instruction. Single Instruction Multiple Data (SIMD) operation is a known technique whereby data words being manipulated in accordance with the single instruction in fact represent multiple data values within those data words with the manipulation specified being independently performed on respective data values.

The present invention makes use of a SIMD type operation, but applies it to the process of saturation to significantly improve the efficiency of the saturation process. Further, to improve flexibility, the saturation instruction is arranged to include a field which enables the bit position to which saturation is to take place to be specified, thereby enabling the same instruction to be used to saturate in parallel a plurality of data values to an arbitrary bit position.

It will be appreciated that, in principle, the saturation instruction may include a field of sufficient size to enable a different bit position to be specified for each data value within the data word Rm, thereby enabling each data value to be saturated to a different bit position via the same saturation instruction. However, in practice, there are unlikely to be many applications where such a feature is required, and instead in preferred embodiments the specified bit position is the same for each of the plurality of data values.

It will be appreciated that the input data word Rm and the output data word Rd may be stored in any appropriate storage accessible by the data processing unit. However, in preferred embodiments the data processing unit is arranged to store the data words that it requires within registers, and the data processing apparatus further comprises a source register for storing the data word Rm and a destination register for storing the result data word Rd.

From the earlier discussion of the saturation process, it will be appreciated that in certain situations the saturated data value is identical to the original unsaturated data value, whereas in other instances, the saturated data value will in fact differ from the original unsaturated data value, in particular where the magnitude of the original data value exceeded the range available for the saturated data value. In preferred embodiments of the present invention, the data processing unit is arranged on completion of the saturation operation to set a flag if any of the data values were outside of the range of an ‘n’ bit number corresponding to the determined bit position. Hence, by this approach, it can be determined whether any of the saturated data values do in fact differ from the input unsaturated data values.

In preferred embodiments, two forms of the saturation instruction are provided, the first being a signed saturation instruction used when the plurality of saturated data values to be produced are signed data values, and the second being an unsigned saturation instruction used when the plurality of saturated data values to be produced are unsigned data values.

The saturation instruction provided in accordance with preferred embodiments of the present invention is particularly effective in applications where saturation operations need to be performed frequently, and to different precisions. Furthermore, it has been found that the use of such a saturation instruction is particularly beneficial when combined with certain other instructions. For example, in one preferred embodiment, the saturation instruction is used in combination with a pack instruction to enable operations to be applied in parallel to selected data values. It will be appreciated that pack instructions can take a variety of forms. However, one type of pack instruction which can be used in combination with the saturation instruction to particularly good effect is a pack instruction wherein the data processing unit is arranged prior to execution of the saturation instruction to be responsive to the pack instruction to perform an operation on a first data word and a second data word, both the first and second data words comprising a number of data values, wherein the operation yields a value given by: selecting a first data value of said first data word extending from one end of said first data word; selecting a second data value of said second data word starting from a bit position specified as a shift operand within the pack instruction; and combining the first and second data values to form respective different data values of said data word Rm.

This pack instruction is a particularly efficient packing instruction that allows different portions of two input operand data words to be combined within a packed output data word using a single instruction. Furthermore, the pack instruction provides a shift operand that allows one of the data values being packed to be selected from a variable position within its input operand data word in a manner that provides the ability to combine an additional data manipulation with the packing operation, e.g. one of the data values to be combined into the packed output data word may be multiplied or divided by a power of two at the same time that it is being packed together with another data value.

In another particularly efficient implementation, the saturation instruction of preferred embodiments is used in combination with an arithmetic instruction to enable operations to be applied in parallel to selected data values. Again, it will be appreciated that an arithmetic instruction may take a variety of forms. However, a particular arithmetic instruction which can be used in combination with the saturation instruction to particularly good effect is an arithmetic instruction wherein the data processing unit is arranged prior to execution of the saturation instruction to be responsive to the arithmetic instruction to perform an operation on a first data word and a second data word, wherein the operation yields a value given by: selecting a plurality of non-adjacent multibit portions of said first data word to form a plurality of multibit portions each of bit length A; optionally shifting said plurality of multibit portions by a common shift amount to shifted bit positions; promoting each of said plurality of multibit portions from said bit length of A to a bit length of B to form a plurality of promoted multibit portions, such that said promoted multibit portions may be abutted to form a promoted data word P; and performing a plurality of independent arithmetic operations using as input operands respective bit position portions of bit length B from both said promoted data word P and said second data word to form said data word Rm comprising a plurality of data values of bit length B.

The arithmetic instruction as described above serves to partially unpack data values held within a data word and also to perform a single-instruction-multiple-data type arithmetic operation upon the partially unpacked data values. This arithmetic instruction recognises that by unpacking non-adjacent data values within a data word, the process may be implemented with considerably less additional overhead than conventional unpacking instructions which unpack adjacent data values. In particular, the need for additional data pathways that can diverge the bit positions of previously adjacent data values may be avoided. Instead, for example, already present masking and word shifting circuitry may be utilised. Furthermore, the simplification of the unpacking functions allows the possibility for a single instruction to also provide an arithmetic operation upon the operands without introducing processing cycle constraint problems.

As will be discussed in more detail later, the use of the saturation instruction of preferred embodiments in combination with such a pack instruction and/or an arithmetic instruction may be used to particularly good effect in a variety of situations, for example when performing the motion compensation part of an MPEG decode function.

It will be appreciated that there are many different ways in which the circuitry may be developed for performing the saturation operation specified by the saturation instruction. In preferred embodiments, the data word Rm comprises in a first mode of operation said plurality of data values and in a second mode of operation a single data value, and said data processing unit comprises: a plurality of logic circuits corresponding to the plurality of data values within the data word Rm in the first mode of operation, each logic circuit being arranged to perform the independent saturation operation on the corresponding data value; and coupling logic arranged, in said second mode of operation, to cause the plurality of logic circuits to operate together to saturate the single data value.

Hence, in accordance with preferred embodiments of the present invention, the same circuitry can be used in two separate modes of operation, such that in a first mode of operation, a plurality of data values within a data word Rm can be saturated in parallel using the saturation instruction of preferred embodiments of the present invention, whilst in a second mode of operation, a single data value can be saturated, thereby facilitating compatibility with former saturate instructions that would typically operate on only a single data value.

In preferred embodiments, each logic circuit comprises a selector for selecting the corresponding data value if that corresponding data value is within the range of an ‘n’ bit number corresponding to the determined bit position, or a mask value if that corresponding data value is outside of the range of the ‘n’ bit number, the mask value being dependent on the determined bit position.

In preferred embodiments, a lookup table or circuit is provided containing mask values for particular determined bit positions, as mentioned earlier the determined bit positions to which saturation is to take place being determined from data within a field of the saturation instruction. Preferably, for any particular determined bit position, a number of different mask values will be provided, and a particular mask value will be chosen depending on whether the data processing apparatus is operating in the first or second mode of operation.

In preferred embodiments, the coupling logic is arranged to be activated in the second mode of operation such that, if a particular logic circuit determines that the mask value should be selected, the coupling logic is arranged to cause each logic circuit processing less significant bits of the data value to select the mask value. This is required since, in the second mode of operation, the determined bit position to which saturation is to take place may fall within the range of bits being processed by any one of the plurality of logic circuits, and accordingly if any one of the logic circuits determines that the mask value should be selected, since the data value falls outside of the range of an n-bit number corresponding to the determined bit position, then it is clear that each of the logic circuits processing less significant bits of the data value should also select the relevant bits of the mask value. It has been found that any logic circuits handling more significant bits of the data value do not need to be forced to select the mask value via the coupling logic, since the relevant bits of the data value will either already have the correct value for the saturated data value or the corresponding logic circuit will cause the correct data value to be generated by selection of the mask value.

In preferred embodiments, the mode of operation is indicated by a signal received by the coupling logic and derived from the instruction being executed by the data processing unit. More particularly, in preferred embodiments, a SIMD signal is input to the coupling logic, which is set when using the saturation instruction of preferred embodiments of the present invention to saturate in parallel a plurality of data values, and is reset if a different saturation instruction is used to saturate a single data value.

Viewed from a second aspect, the present invention provides a method of operating a data processing apparatus comprising a data processing unit for executing instructions, the method comprising the steps of: in response to a saturation instruction, causing the data processing unit to apply a saturation operation to a data word Rm comprising a plurality of data values, wherein said saturation operation yields a value given by: determining from data provided within a field of the saturation instruction a bit position to which saturation is to take place; and performing in parallel an independent saturation operation on each of the data values to saturate each of the data values to the determined bit position to form a result data word Rd comprising a plurality of saturated data values.

Viewed from a third aspect, the present invention provides a computer program operable to configure a data processing apparatus to perform a method in accordance with the second aspect of the present invention. The invention also relates to a carrier medium comprising such a computer program. The carrier medium may be any suitable device, for example a CDROM, a diskette, etc., or indeed may be a transmission medium such as an optical fiber, radio signal, etc.

### BRIEF DESCRIPTION OF THE DRAWINGS

The present invention will be described further, by way of example only, with reference to a preferred embodiment thereof as illustrated in the accompanying drawings, in which:

FIG. 1 schematically illustrates the action of a saturation instruction in accordance with preferred embodiments of the present invention;

FIG. 2 is a flow diagram illustrating the operation of a saturation instruction in accordance with preferred embodiments of the present invention;

FIG. 3A is a block diagram illustrating the circuitry employed within a data processing apparatus in preferred embodiments of the present invention to facilitate execution of the saturation instruction;

FIGS. 3B and 3C illustrate example data flows through the circuitry of FIG. 3A;

FIG. 4 schematically illustrates the action of a SIMD type arithmetic instruction;

FIG. 5 schematically illustrates the data path within a data processing apparatus of a type suited to executing the arithmetic instruction of FIG. 4;

FIGS. 6 and 7 schematically illustrate two variants of a SIMD type pack instruction; and

FIG. 8 schematically illustrates the data path of a data processing apparatus of a type suited to executing the pack instruction of FIGS. 6 and 7.

### DESCRIPTION OF PREFERRED EMBODIMENT

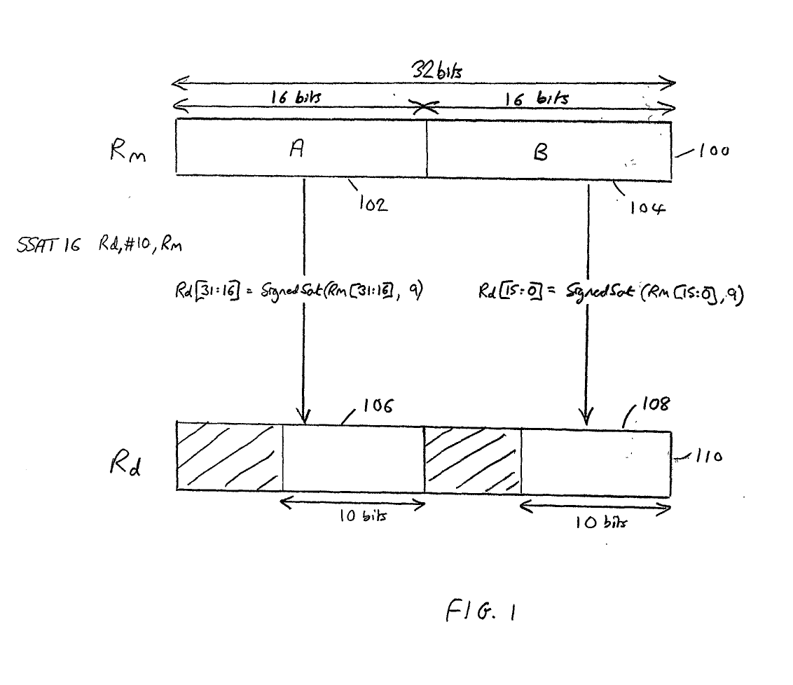

FIG. 1 illustrates the action of a SIMD type saturation instruction termed SSAT16. An abbreviated Backus-Naur description of the SSAT16 instruction is provided below:

SSAT16{<cond>} <Rd>, #<sat_immed>, <Rm>

Where

<cond> Is the condition under which the instruction is executed.

<Rd> Specifies the destination register of the instruction.

<sat_immed> Specifies the number of bits on the result of the signed saturation, and lies in the range 1 to 16. The value immed is derived as being sat_immed−1, and so lies in the range 0 to 15.

<Rm> Specifies the register that contains the value to be saturated.

The SSAT16 instruction performs signed saturation at an arbitrary bit position (as specified by the immed field of the instruction) on a pair of 16-bit halfwords held in a single 32-bit register.

As will be appreciated by those skilled in the art, in the abbreviated Backus-Naur form, items in braces “{. . . }” indicate optional items, and hence a specification of a cond field within the SSAT instruction is optional. If the cond field is not present, then the SSAT instruction is always executed.

Assuming the condition under which the instruction is to be executed is met, or if no condition is specified, then the SSAT instruction is arranged to cause the following operation to be performed:

Immed=sat_immed−1

Rd[15:0]=SignedSat(Rm[15:0], immed)

Rd[31:16]=SignedSat (Rm[31:16], immed)

if SignedDoesSat (Rm[15:0], immed) OR SignedDoesSat (Rm[31:16], immed)

then Q Flag=1

The two SignedSat operations are illustrated schematically in FIG. 1, where the SSAT16 instruction is applied to register Rm, causing the SignedSat operation to be executed on the two halfwords 102, 104 within register Rm 100. In this example, the sat_immed field is set to 10, indicating that saturated result should be a 10 bit number. Hence, for the halfword A 102 specified by the top 16 bits in register Rm 100, saturation will occur at bit position 25, whilst for halfword B 104, saturation will occur at bit position 9, resulting in the generation of two 10-bit words, 106, 108 in the result data word Rd 110.

In preferred embodiments, the top six bits in each halfword of the result data word Rd 110 will be set to 1s for negative signed numbers, and to 0s for positive signed numbers or unsigned numbers.

The SignedSat operation is arranged to return a data value x saturated to the range of an n-bit signed integer, where n is equivalent to immed+1, given that in a 16-bit number the bits are specified as bits 0 to 15. Thus, SignedSat (x, immed) produces a data value x_{OUT} as follows:

n=immed+1;

| | |
|---|---|
| If x < −2ⁿ⁻¹ | x_{OUT} = −2ⁿ⁻¹ |
| If −2^{n-1 ≦x≦2}ⁿ⁻¹ −1 | x_{OUT} = x |
| If x > 2ⁿ⁻¹ −1 | x_{OUT} = 2ⁿ⁻¹ −1 |

In the example illustrated in FIG. 1, immed is equal to 9, and accordingly n is equal to 10.

In preferred embodiments, the SSAT16 instruction also causes the operation SignedDoesSat to be performed in parallel on the top and bottom 16 bits of the data word Rm. This operation preferably returns a logic zero value if the original data value lies within the range of the n-bit signed integer (that is, if −2ⁿ⁻¹≦x≦2ⁿ⁻¹−1), and returns a logic one value otherwise. The output of the two SignedDoesSat operations are then ORed together to produce a flag value. This operation delivers further information about the SignedSat operations, and any operations used to calculate x or immed are not repeated.

For completeness, the following table illustrates how the various fields of the SSAT16 instruction may be specified using a 32-bit instruction word:

TABLE 1

| | | | | | | |
|---|---|---|---|---|---|---|
| 31..28 | 27..20 | 19..16 | 15..12 | 11..8 | 7..4 | 3..0 |
| Cond | 0110 1010 | immed | Rd | SBO | 0011 | Rm |

Bits 27 to 20, 11 to 8 and 7 to 4 in combination represent the opcode of the instruction, and hence uniquely identify the SSAT16 instruction (the term SBO indicating “Should Be One”).

In addition to the SSAT16 instruction, an equivalent instruction is provided to produce unsigned saturated numbers, hereafter referred to as USAT16. As with the SSAT16 instruction, the input data values are signed data values. The format of the USAT16 instruction is similar to that of the SSAT16 instruction, and can be indicated in the abbreviated Backus-Naur form as follows:

USAT16{<cond>} <Rd>, #<immed>, <Rm>

Where:

<cond> Is the condition under which the instruction is executed.

<Rd> Specifies the destination register of the instruction.

<immed> Specifies the bit position at which unsigned saturation should take place, and lies in the range 0 to 15.

<Rm> Specifies the register that contains the value to be saturated.

Accordingly, the USAT16 instruction performs unsigned saturation at an arbitrary bit position on a pair of halfwords held in a register Rm.

Assuming any condition that is specified is met, the USAT16 instruction is arranged to cause the following operation to be performed:

Rd[15:0]=UnsignedSat (Rm[15:0], immed)/* Note: Rm[15:0] regarded as signed value */

Rd[31:16]=UnsignedSat [Rm[31:16], immed)/* Note: Rm[31:16] regarded as signed value */

If UnsignedDoesSat (Rm[15:0], immed) OR UnsignedDoesSat (Rm[31:16], immed) then Q Flag=1

In an analogous manner to the operation SignedSat (x, immed), UnsignedSat (x, immed) returns x saturated to the range of an n-bit unsigned integer, where n is in this case equal to immed. Hence, the operation UnsignedSat produces an output saturated data value x_{OUT} as follows:

n=immed;

| | |
|---|---|
| If x < 0 | x_{OUT} = 0 |
| If 0 ≦x≦2ⁿ −1 | x_{OUT} = x |
| If x > 2ⁿ −1 | x_{OUT} = 2ⁿ −1 |

Similarly, the operation UnsignedDoesSat operates in a similar manner to the operation SignedDoesSat to return 0 if x lies within the range of an n-bit unsigned integer (that is, if 0≦x≦2ⁿ−1), and 1 otherwise. Again, any operations used to calculate x or immed are not repeated.

For completeness, the following table illustrates how the USAT16 instruction can be specified using a 32-bit instruction word in accordance with preferred embodiments of the present invention:

TABLE 2

| | | | | | | |
|---|---|---|---|---|---|---|
| 31..28 | 27..20 | 19..16 | 16..12 | 11..8 | 7..4 | 3..0 |
| Cond | 0110 1110 | immed | Rd | SBO | 0011 | Rm |

As with the SSAT16 instruction, bits 27 to 20, 11 to 8 and 7 to 4 in combination represent the opcode of the instruction, and hence uniquely identify the USAT16 instruction (the term SBO indicating “Should Be One”).

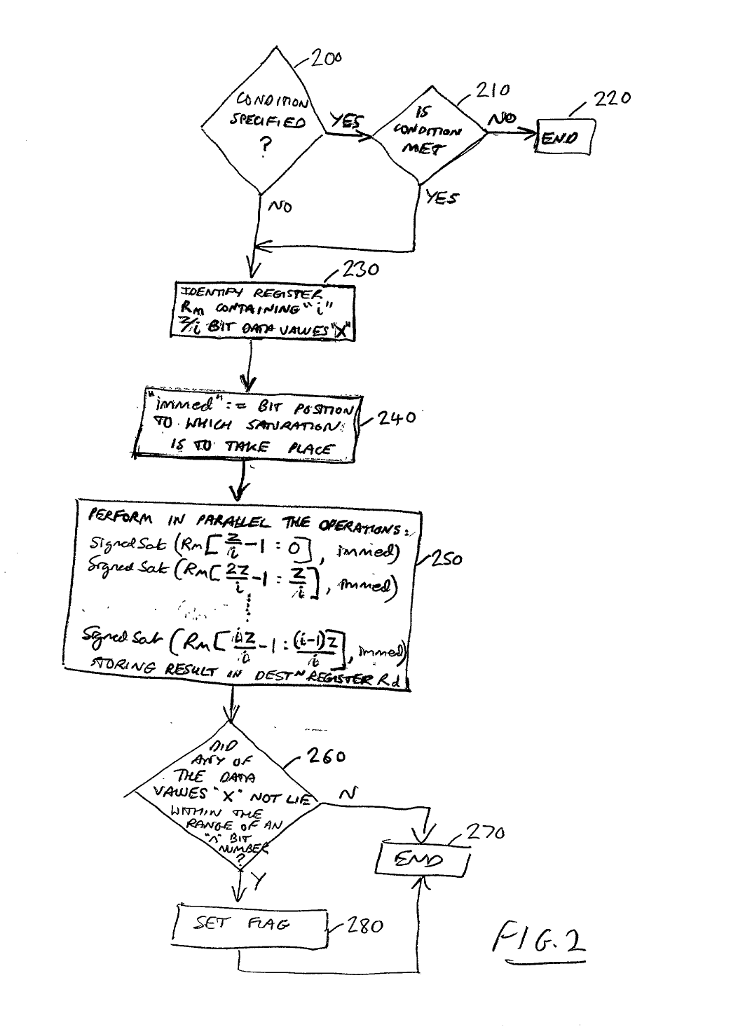

Whilst in preferred embodiments the saturate instructions SSAT16 and USAT16 perform independent saturation of two 16-bit halfwords in a 32-bit register, it will be appreciated that derivatives of these instructions can be produced to simultaneously perform saturation on any appropriately sized data values within a register of a size sufficient to hold multiple of such data words. Accordingly, FIG. 2 is a flow diagram illustrating the operation performed by a generic signed saturate instruction arranged to saturate in parallel i data values within a z-bit register.

At step 200, it is determined whether any condition is specified in the signed saturate instruction. If it is, then the process branches to step 210, where it is determined whether the condition is met. If it isn't, the process ends at step 220, whereas if the condition is met, or no condition is specified, the process proceeds to step 230.

At step 230, the source register Rm is identified from the instruction, this register Rm containing i z/i-bit data values. Hence, taking the earlier example, if the register is a 32-bit register, and two data values are placed in the register, then each of the data values will be 16-bits. However, as other examples, a 64-bit register may contain four 16-bit data values, or indeed a 32-bit register may contain four 8-bit data values.

At 240, the value “immed” is determined from the instruction, this specifying the bit position to which saturation is to take place. Then, at step 250, a number of SignedSat operations are performed on the various data values within the source register Rm, this resulting in saturated versions of the input data values being stored in the destination register Rd. As will be apparent, if there are two data values in the source register Rm, then two SignedSat operations will be performed, if there are four data values within the source register Rm, four SignedSat operations will be performed, etc.

The process then proceeds to step 260, where it is determined whether any of the data values did not lie within the range of an n-bit number, where in preferred embodiments n is equal to immed+1. If all of the values did lie within the range of an n-bit number, then no further action is required, and the process terminates at step 270. However, in preferred embodiments, if any of the data values did not lie within the range of an n-bit number, the process proceeds to step 280, where a flag is set. The process then proceeds to step 270 where the process terminates.

It will be appreciated that an identical flow diagram can be produced for a generic unsigned saturate instruction, but in this instance, the references to the operation SignedSat in box 250 would be replaced with references to the operation UnsignedSat, and additionally n is equal to immed for the unsigned saturate instruction.

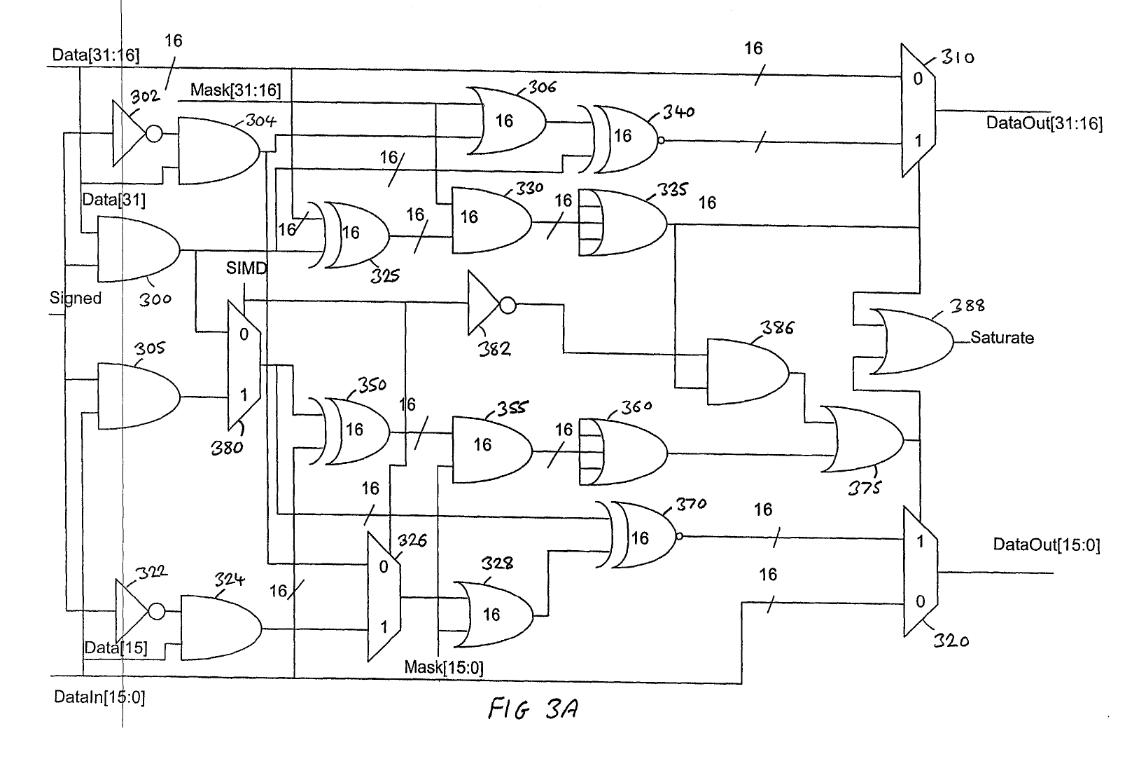

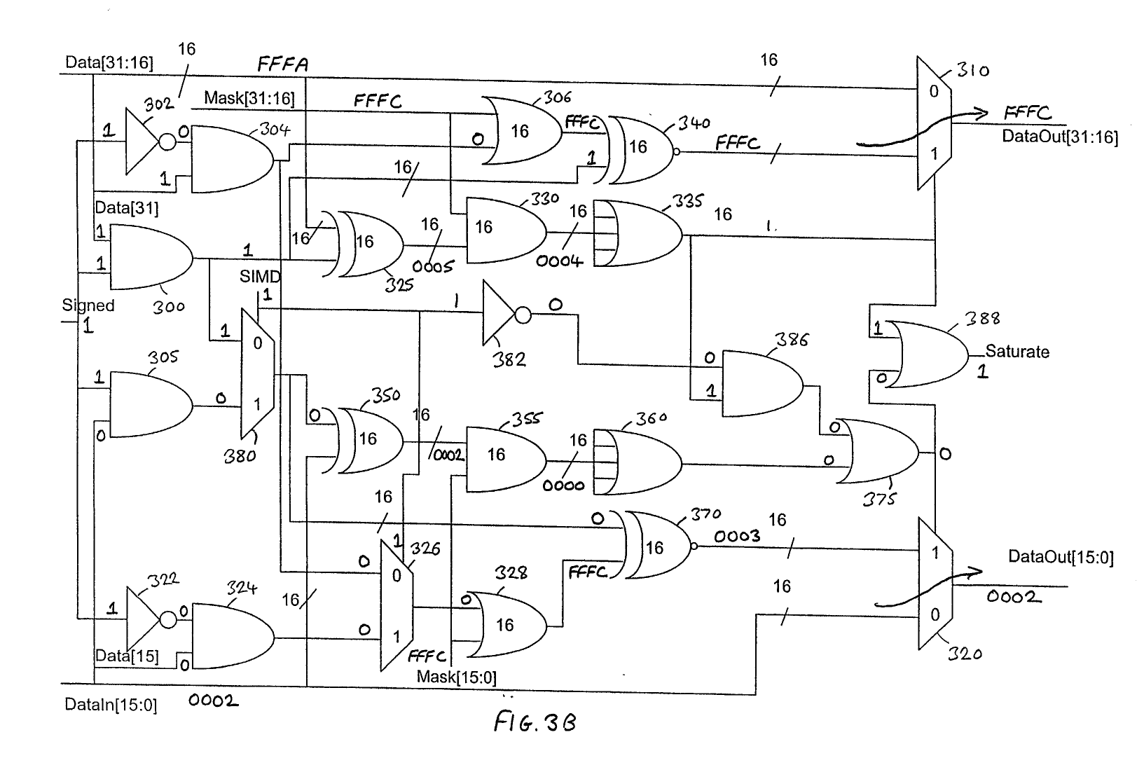

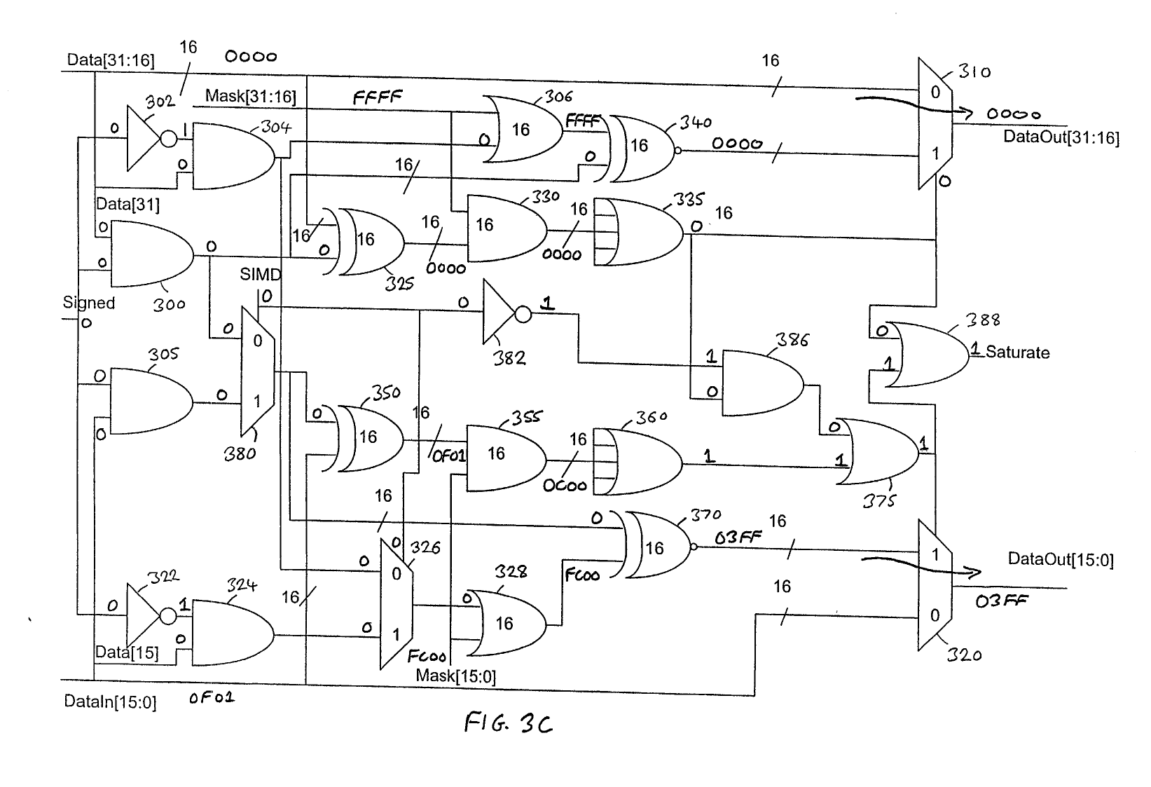

FIG. 3A is a block diagram illustrating the saturation logic provided in preferred embodiments of the present invention to execute the SIMD type signed and unsigned saturate instructions of preferred embodiments of the present invention, whilst also facilitating execution of a non-SIMD type saturate instruction in situations where only a single data value is specified in the source register Rm. Hence, this circuitry can be used to perform saturation of a single 32-bit data value, or to perform in parallel saturation of two 16-bit data values specified by the upper and lower halfwords of the source register Rm.

The circuit requires the use of a 32-bit mask value, with bits 31 to 16 of the mask being conditionally input to exclusive NOR gate 340, whilst bits 15 to 0 of the mask are conditionally input to exclusive NOR gate 370. The mask will be dependent on the bit position to which saturation is to take place, and will also be dependent on whether a SIMD type saturate of two 16-bit data values is being performed or whether a single saturate of a 32-bit data value is being performed. A signal “Signed” is input to AND gates 300 and 305, and will be set to zero if unsigned saturated data values are to be produced, and will be set to one if signed saturated data values are to be produced (as mentioned earlier, both the SSAT16 and USAT16 instructions use signed data values as input values). In addition, a signal SIMD is input to multiplexers 380,326 and inverter 382, which will be set to zero if a standard saturate of a single 32-bit data value is being performed, and will be set to one if a SIMD type saturate instruction of preferred embodiments is being used to saturate in parallel two 16-bit data values. Table 3 below provides details of the mask value used in preferred embodiments dependent on the value of the SIMD signal, and the value of immed identifying the bit position to which saturation is to take place:

TABLE 3

| Immed | SIMD = 0 | SIMD = 1 |
|---|---|---|
| 0 | 0xFFFFFFFF | 0xFFFFFFFF |
| 1 | 0xFFFFFFFE | 0xFFFEFFFE |
| 2 | 0xFFFFFFFC | 0xFFFCFFFC |
| 3 | 0xFFFFFFF8 | 0xFFF8FFF8 |
| 4 | 0xFFFFFFF0 | 0xFFF0FFF0 |
| 5 | 0xFFFFFFE0 | 0xFFE0FFE0 |
| 6 | 0xFFFFFFC0 | 0xFFC0FFC0 |
| 7 | 0xFFFFFF80 | 0xFF80FF80 |
| 8 | 0xFFFFFF00 | 0xFF00FF00 |
| 9 | 0xFFFFFE00 | 0xFE00FE00 |
| 10 | 0xFFFFFC00 | 0xFC00FC00 |
| 11 | 0xFFFFF800 | 0xF800F800 |
| 12 | 0xFFFFF000 | 0xF000F000 |
| 13 | 0xFFFFE000 | 0xE000E000 |
| 14 | 0xFFFFC000 | 0xC000C000 |
| 15 | 0xFFFF8000 | 0x80008000 |
| 16 | 0xFFFF0000 | N/A |
| 17 | 0xFFFE0000 | N/A |
| 18 | 0xFFFC0000 | N/A |
| 19 | 0xFFF80000 | N/A |
| 20 | 0xFFF00000 | N/A |
| 21 | 0xFFE00000 | N/A |
| 22 | 0xFFC00000 | N/A |
| 23 | 0xFF800000 | N/A |
| 24 | 0xFF000000 | N/A |
| 25 | 0xFE000000 | N/A |
| 26 | 0xFC000000 | N/A |
| 27 | 0xF8000000 | N/A |
| 28 | 0xF0000000 | N/A |
| 29 | 0xE0000000 | N/A |
| 30 | 0xC0000000 | N/A |
| 31 | 0x80000000 | N/A |

The operation of the circuitry of FIG. 3A will no doubt be apparent to those skilled in the art. However, a brief discussion with reference to some specific examples will be provided below.

Firstly, assuming an SSAT16 instruction is to be executed on two signed 16-bit data values, then it will be clear that the signal SIMD will be set to one, this causing the output of inverter 382 to be at a logic zero value, thereby ensuring that the output of AND gate 386 is at a logic zero value irrespective of the value of the other input to that AND gate. This in turn will ensure that the output of OR gate 375 is dependent solely on the output of OR gate 360.

Since the signal “Signed” is at a logic one value, then AND gates 300 and 305 will output a logic one value if the top bit of the respective two 16-bit data values is a logic one value, i.e. if the corresponding 16-bit data value represents a negative number. Otherwise the AND gates will output a logic 0 value. Accordingly, AND gate 300 will output a one if the 16-bit data value specified by bits 31 to 16 of register Rm is a negative number and signed saturated data values are to be generated, whilst AND gate 305 will output a logic one value if the data value represented by bits 15 to 0 of register Rm is a negative number and signed saturated data values are to be generated.

Dealing first with the circuitry arranged to process the top halfword of register Rm, the 16 exclusive OR (XOR) gates 325 will receive the top halfword, along with the output of AND gate 300. The operation of the XOR gates 325 is such that the 16 bits of the top halfword will be output unchanged if the signal received from AND gate 300 is a logic 0 value, whereas each input bit will be inverted by the XOR gates 325 if the output of AND gate 300 is a logic one value, e.g. a sequence of bits 1100 will be converted by XOR gates 325 to a sequence of bits 0011 in the presence of a logic one value output from AND gate 300.

The sixteen AND gates 330 are arranged to receive the output of XOR gates 325, and the top 16 bits of the mask value. For a SIMD type saturation of two 16-bit data values, the top 16 bits of the mask value will be the same as the bottom 16 bits of the mask value, and will represent the inverse of the largest possible number that can be expressed in the saturated result.

Hence, it can be seen that AND gates 330 will output a 16-bit value, with only bits where the mask value is 1, and the corresponding bit of the output from XOR gates 325 is 1 being set to 1 in the output from AND gates 330. Since in the generation of signed saturated numbers, negative signed values were inverted by XOR gates 325, whilst otherwise the signed input values were left “as is”, it will be appreciated that this has the effect that the output from AND gates 330 will be all zeros, unless the data value is outside of the range of the n bit number specified by the top 16 bits of the mask. Accordingly, OR gate 335 is arranged to check for the presence of any logic one values, by ORing together all of the 16 bits.

Hence, it can be seen that a logic 1 value output from OR gate 335 will indicate that the data value is out of range, and will need saturating to the maximum positive number or maximum negative number, dependent upon whether the number is positive or negative, causing multiplexer 310 to select the 16-bit value output from XNOR gates 340 in the presence of a logic 1 value or to select the original 16-bit data value in the presence of a logic 0 value.

The sixteen XNOR gates 340 conditionally receive the top 16 bits of the mask, along with the output from AND gate 300, which as mentioned earlier will be set to a logic 1 value if the number is a negative signed number and signed saturated data values are to be produced. The conditioning of the mask input to XNOR gates 340 is achieved by inverter 302, AND gate 304 and the sixteen OR gates 306. More particularly, if signed saturated data values are to be produced, inverter 302 will output a logic zero value, which will cause AND gate 304 to output a logic zero value irrespective of the value of its other input. This in turn will cause the OR gates 306 to output the mask value unaltered to the XNOR gates 340. If unsigned saturated data values are to be produced, inverter 302 will output a logic one value, which will cause AND gate 304 to output its other input. Hence, if the input data value represented by bits 31 to 16 is positive, bit 31 will be a logic zero value, the output of AND gate 304 will be a logic zero value, and accordingly OR gates 306 will output the mask “as is”. However, if the input data value is a negative number, bit 31 will be a logic one value, and hence AND gate 304 will output a logic one value. In this instance, this will cause OR gate 306 to output 16 logic one values as the conditioned mask value.

Hence, in summary, logic gates 302, 304 and 306 serve to leave the mask “as is” except when the input data value is negative and unsigned saturated data values are to be produced, in which event these logic gates force the mask to “all ones”.

The operation of XNOR gates 340 is such that in the presence of a logic 1 value at one of their inputs, they will output the other input “as is”, whereas in the presence of a logic 0 value at one of their inputs, they will invert the other input. Accordingly, it can be seen that XNOR gates 340 output the mask “as is” if the input data value is a negative signed number and signed saturated data values are to be produced, and inverts the mask otherwise. This in effect produces a mask representing the maximum positive number if the input data value is a signed positive value. Further, if the input data value is a signed negative value and unsigned saturated data values are to be produced, then the input mask is all ones, and the inverted mask output by the XNOR gates 340 is all zeros (i.e. the minimum value allowed for an unsigned saturated number).

Accordingly, it can be seen that, when producing signed saturated data values, multiplexer 310 will output the original data value if it is still within range of the n bit number, will output a data value equal to −2ⁿ⁻¹ for signed negative data values which are out of range, and will output a data value equal to 2ⁿ⁻¹−1 if the original data value was a signed positive data value which was out of range. Further, when producing unsigned saturated data values, multiplexer 310 will output the original data value if it is still within range of the n bit number, will produce a logic zero value if the original data value is less than zero, or will produce a data value equal to 2ⁿ−1 if the original data value was a signed positive data value which was out of range.

It will be seen that the lower half of the circuitry works in an analogous manner to the top half of the circuitry, with the gates 350, 355 and 360 replicating the function of gates 325, 330 and 335, and with XNOR gate 370 replicating the function of XNOR gate 340. However, one difference is the presence of multiplexer 380, which in the presence of a SIMD saturation on two 16-bit numbers is arranged to output the signal received from AND gate 305, thus effectively uncoupling the top half of the circuitry from the bottom half. However, in the event that a single saturation of a 32-bit number is being performed, then the multiplexer 380 is arranged to select as its output the output from AND gate 300, since in that event it is only bit 31 which will carry any sign information.

Additionally, the logic gates 322, 324 and 328 replicate the function of logic gates 302, 304 and 306. However, multiplexer 326 is additionally provided so that in the event of saturation of a 32-bit number, the output of AND gate 304 is passed to OR gates 328 rather than the output of AND gate 324.

As mentioned earlier, in the presence of a SIMD saturation, the output of AND gate 386 will always be at a logic zero value, and hence the output from that AND gate will have no bearing on the output from OR gate 375. However, in the presence of a saturation of a 32-bit number, the value of the SIMD signal will be 0, causing the AND gate 386 to receive a logic 1 value at one of its inputs. Further, if OR gate 335 produces a logic 1 value, indicating that the 16 bits being evaluated is out of range, then in addition to this triggering a logic 1 value being input to multiplexer 310, it will also cause the output of AND gate 386 to transition to a logic 1 value, thereby triggering the output of a logic 1 value from OR gate 375. This will ensure that both multiplexers 310 and 320 output a data value generated from the mask, rather than the original data value.

A similar coupling circuitry is not required in preferred embodiments to cover the reverse situation, since if the output of OR gate 360 is at a logic one value, indicating that the data value is out of range, the top 16 bits of the input data value will always either already have the correct value for the saturated data value or will automatically be set to the correct value by a logic one value being output from OR gate 335 to cause the mask value to be selected (i.e. the top 16 bits will already be 0000 or 1111, or will be set to 0000 or 1111 by selection of the mask value).

It should be noted that OR gate 388 is also provided, which will generate a logic 1 value at its output whenever it is determined that a data value is out of range of an n bit number to which saturation is taking place, and accordingly the output of OR gate 388 can be arranged to set a flag if any of the data values being evaluated are outside of the range of the n bit number.

FIG. 3B illustrates an example flow of data through the circuitry of FIG. 3A in a situation where it is being used to saturate two signed 16-bit data values to 3-bit signed data values. In FIG. 3B, hexadecimal notation is used to refer to the 16-bit numbers. In this example, the first 16-bit number is FFFA, i.e. −6, and the second 16-bit data value is 0002, i.e. 2. With reference to Table 3, it will be seen that when performing a SIMD type signed saturation to 3 bits (i.e. immed equals 2), the top 16-bits of the mask value and the bottom 16-bits of the mask value are both FFFC, i.e. −4, this being in accordance with the earlier algorithms where it was indicated that the maximum negative number was −2ⁿ⁻¹ for signed saturation of signed data values to n bits.

Looking firstly at the top half of the circuitry, it will be seen that the output of AND gate 300 is a logic 1 value, given that the output data values are to be signed, and the top bit of the first data value is a logic 1 value. This will cause XOR gates 325 to invert FFFA, thereby producing 0005. AND gates 330 will receive at its inputs the mask value FFFC, and the value 0005, this causing an output of 0004 to be generated. This in turn will cause a logic 1 value to be output from OR gate 335, which will be input to the multiplexer 310. This will cause the multiplexer 310 to select the output from XNOR gate 340.

Since a signed saturation is being performed, inverter 302 will output a logic zero value, which will cause AND gate 304 to output a logic zero value to OR gates 306. This will cause the mask value to be output “as is” to the input of XNOR gates 340. Given the presence of a logic one 1 at its input connected to AND gate 300, this will cause XNOR gates 340 to output the mask value “as is”. Accordingly, it can be seen that the output from multiplexer 310 is FFFC, i.e. −4, this being the correct result for saturating −6 to a 3-bit signed number.

Looking now at the bottom half of the Figure, AND gate 305 will produce a logic 0 value, since the top bit of 0002 is a logic 0 value. Further, since this is a SIMD operation, multiplexer 380 will select that logic 0 value for outputting to XOR gates 350 and XNOR gates 370. XOR gates 350 will hence output the value 0002 “as is”, and AND gates 355 will output 0000, since the input values 0002 and FFFC do not have any of the same bits set to a logic 1 value. This will cause the output of OR gate 360 to be a logic 0 value. Furthermore, since the output of inverter 382 is a logic 0 value, it will be seen that the output of AND gate 386 is a logic 0 value, and that hence OR gate 375 will output a logic 0 value. This will cause multiplexer 320 to select the original data value 0002 to be output as the result.

For completeness, it should be noted that inverter 322 will output a logic zero value, thereby causing AND gate 324 to output a logic zero value to multiplexer 326. Since a SIMD type saturation is taking place, multiplexer 326 will output the input received from AND gate 324, thereby causing one of the inputs of OR gates 328 to be set to a logic zero value. This will cause the mask value to be output “as is” to XNOR gates 370. XNOR gates 370 will then invert the mask FFFC, given the presence of a logic zero value at their other inputs (since the relevant input data value is a positive number), this producing a new mask 0003, this representing the maximum positive number, as expected from the earlier equations which indicated that the maximum positive number is −2ⁿ⁻¹−1. Nevertheless, the original data value 0002 is within range, and hence is output by multiplexer 320.

FIG. 3C is a second example of the data flow through the circuit of FIG. 3A, in this example a single 32-bit data value 00000F01 being saturated to a 10-bit unsigned data value. As is clear from Table 3, when performing unsigned saturation of a 32-bit number to 10 bits, the mask is FFFFFC00, since here immed equals n.

Looking first at the top part of the figure, the output of AND gate 300 will be at a logic 0 value, since the Signed signal will be set equal to 0, and accordingly XOR gates 325 will output the original data value “as is”. It is clear that this will cause AND gates 330 to output 0000, which in turn will cause OR gate 335 to output a logic 0 value.

Inverter 302 will output a logic one value, but AND gate 304 will still output a logic zero value given that bit 31 of the input data value will be zero. This will cause OR gates 306 to output the mask value “as is”. However, since AND gate 300 produces a logic 0 value, XNOR gate 340 will invert the mask value FFFF, producing a new mask value of 0000.

Since OR gate 335 produces a logic zero value, the original top 16 bits of the data value will be output as is, and hence 0000 will be output from multiplexer 310.

Looking now at the lower half of the figure, AND gate 305 will also produce a logic 0 value, but since the operation is not a SIMD operation, multiplexer 380 will in any case select the output of AND gate 300, which is also a logic 0 value. This will cause XOR gates 350 to output the lower 16-bits of the data value, i.e. 0F01 “as is” and the AND gates 355 will then receive as its inputs 0F01 and FC00. These two numbers have two bit positions which both have a logic 1 value, and accordingly an output of 0C00 will be generated from AND gates 355, which will cause the output of OR gate 360 to be set to a logic 1 value. This will cause the output of OR gate 375 to be set to a logic 1 value.

Inverter 322 will output a logic one value, but AND gate 324 will output a logic zero value given that bit 15 of the data value is a zero. Multiplexer 326 will in any event select the output from AND gate 304 since a non-SIMD saturation is taking place, and hence a logic zero value will be output to OR gates 328. This will cause the mask value to be output as is to XNOR gates 370. Given the presence of a logic 0 value output from multiplexer 380, XNOR gates 370 will invert the mask value FC00, producing a new mask value 03FF. The multiplexer 320 will then be arranged to select the mask value output by XNOR gate 370, thus producing at its output 03FF. This accordingly will produce a final output data value of 000003FF, in binary format this corresponding to the ten least significant bits being set equal to one, with the remaining bits being all set equal to zero. It will apparent that this is indeed the maximum 10 bit number that can be produced, and accordingly it can be seen that the original data value 00000F01 has been saturated to that number.

The above description has discussed the SIMD type saturation instructions used in preferred embodiments of the present invention for signed and unsigned numbers. It has been found that these instructions provide a great deal of flexibility in the choice of bit position to which saturation is to take place, and also significantly improve the efficiency of the saturation process, by enabling multiple data values to be saturated in parallel.

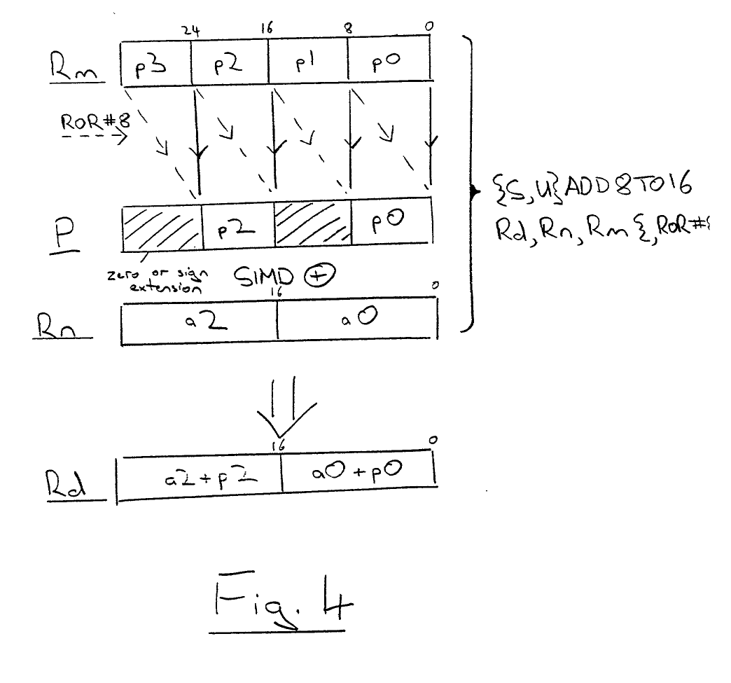

Furthermore, as mentioned earlier, it has been found that in certain situations even greater benefits can be realised by combining the use of these new saturation instructions with certain pack and/or arithmetic instructions. FIGS. 4 through 8 will now be used to describe an example arithmetic instruction termed ADD8TO16 along with an example pack instruction termed PKHTB or PKHBT that may be used in combination with the above new SIMD type saturation instructions.

FIG. 4 illustrates the action of a first SIMD type data processing instruction termed ADD8TO16. This instruction comes in both signed and unsigned variants corresponding to the nature of the extension added to the front of a selected portion of each of the input operand data words as it is extended in length as part of the processing performed. The first input operand data word is stored within a register Rm of the data processing apparatus. The data word is formed of four 8-bit portions p0, p1, p2 and p3. Depending upon whether or not a rotate right operation of 8-bit positions is specified in the instruction, either the multibit portions p0 and p2 or alternatively the multibit portions p1 and p3 are selected out of the input data word within register Rm. The example illustrated in FIG. 4 shows the non-adjacent portions p0 and p2 being selected in the unrotated (shifted) variant with the other variant being indicated by the dotted lines.

When the multibit portions have been selected, each is promoted in length from 8 bits to 16 bits using either zero or sign extension. The shaded portions of the promoted data word P shown in FIG. 4 indicate these extension portions.

The second input data word is stored within a register Rn and comprises two 16-bit data values. The example illustrated performs a single-instruction-multiple-data add operation whereby the extended p0 value is added to the lower 16 bit value a0 of Rn whilst the extended p2 value is added to the upper 16 bit portion a2 of the Rn value. This type of addition is one which may be considered as a full width addition with the carry chain broken between the 15^{th} and 16^{th} bits of the result. It will be appreciated that other SIMD type arithmetic operations may be performed, such as, for example, a SIMD subtraction.

The output result data word generated by the instruction of FIG. 4 produces in the lower 16 bits the sum of p0 and a0 whilst the upper 16 bits contain the sum of p2 and a2. This instruction is particularly useful in operations that determine the sum of absolute differences between respective data values whereby the a0 and a2 represent accumulate values with the values p0 to p3 representing individual absolute values of signal difference values, such as pixel difference values. This type of operation is commonly needed in MPEG motion estimation processing and the ability to perform this operation at high speed is strongly advantageous.

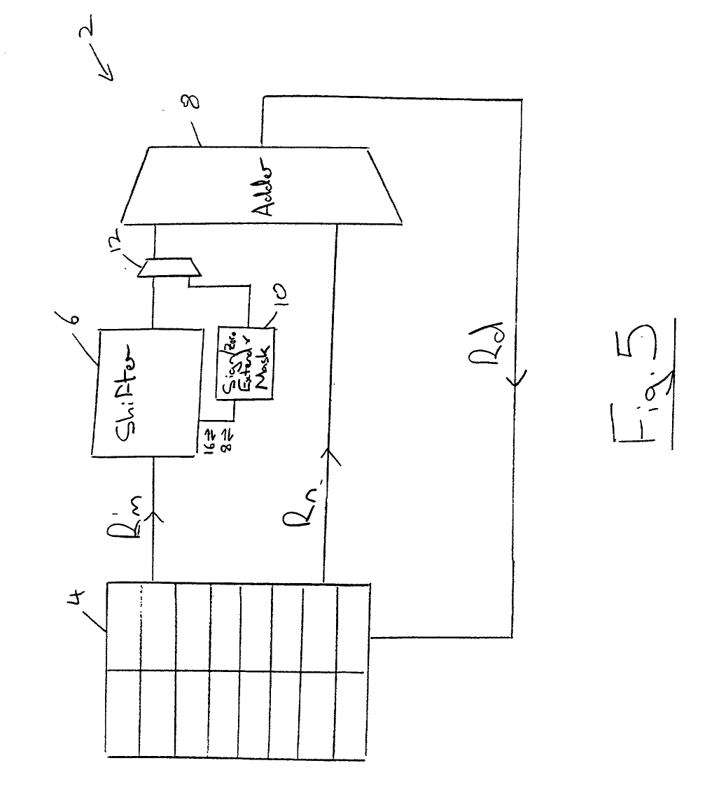

FIG. 5 illustrates an example data path 2 of a data processing system that may be used to implement the instruction of FIG. 4. A register bank 4 holds 32-bit data words to be manipulated. Both the input operand data words stored in Rm and Rn are read from this register bank and the result data word is written back to register Rd in the register bank 4. The data path 2 includes a shifting circuit 6 and an adder circuit 8. The many other data processing instructions provided by the system utilise this shifting circuit 6 and adder circuit 8 in various different ways. Such a data path 2 is carefully designed so that the time taken for a data value to propagate through the shifting circuit 6 and the adder circuit 8 is well matched to the data processing cycle time. Efficient use of the hardware resources of the data path 2 is made in systems in which those resources are active for a high proportion of every data word propagating through the data path 2. A sign/zero extending and masking circuit 10 is provided in parallel with lower portion of the shifting circuit 6. A multiplex 12 is able to select either the output of the full shifting circuit 6 or the output of the sign/zero extending and masking circuit 10 as one of the inputs to the adder circuit 8. The other input to the adder circuit 8 is the input operand data word of Rn.

When executing the instruction of FIG. 4, the input operand data word of Rm is supplied to the shifting circuit 6 in which an optional right shift of 8-bit positions is applied to the data word in dependence upon whether or not that parameter was specified within the instruction. Within a multilevel multiplexer based shifter, such a restricted possibility shift may be provided relatively simply from a first portion of the shifting circuit 6 (e.g. in the case of a 32-bit system the first level of multiplexer may provide 16 bits of shift and the second level of multiplexer provides 8 bits of shift). Accordingly, a value optionally shifted by the specified amount can be tapped off from part way through the shifting circuit 6 and supplied to the sign/zero extending and masking circuit 10. This circuit 10 operates to mask out the non-selected multibit portions of the possibly shifted input operand data word of Rm and replace these masked out portions with either zeros or a sign extension of their respective selected multibit portions. The output of the sign/zero extending and masking circuit 10 passes via a multiplexer 12 to a first input of the adder circuit 8. The second input of the adder circuit 8 is the input operand data word of Rn. The adder circuit 8 performs a SIMD add upon its inputs (i.e. two parallel 16-bit adds with the carry chain effectively broken between bit positions 15 and 16). The output of the adder circuit 8 is written back into register Rd of the a register bank 4.

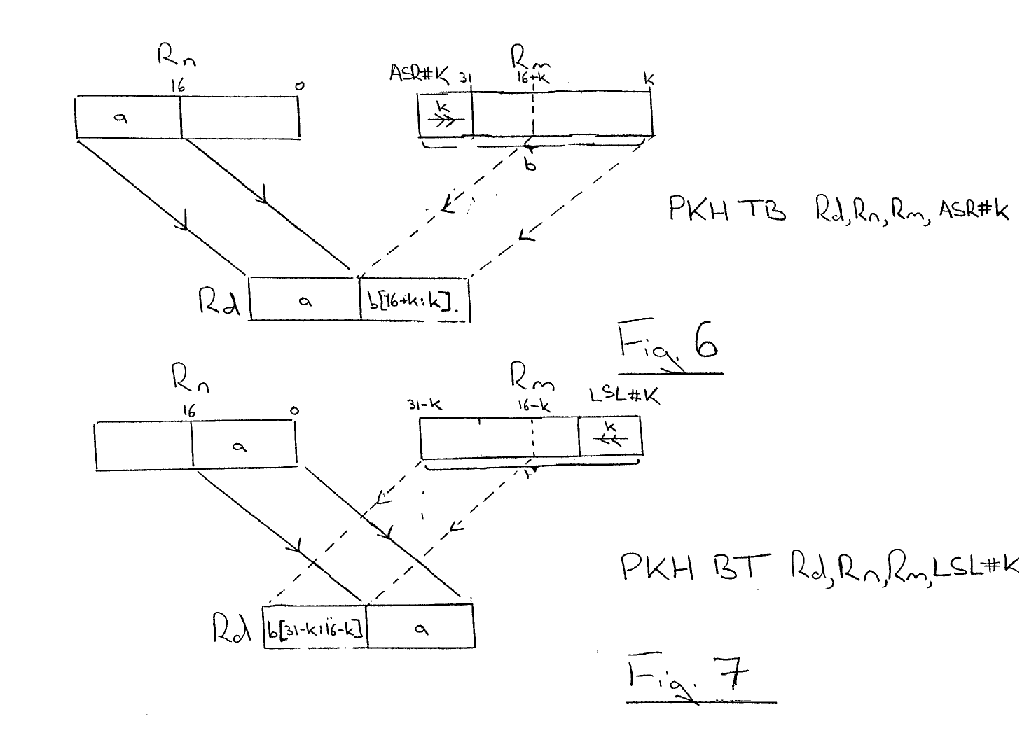

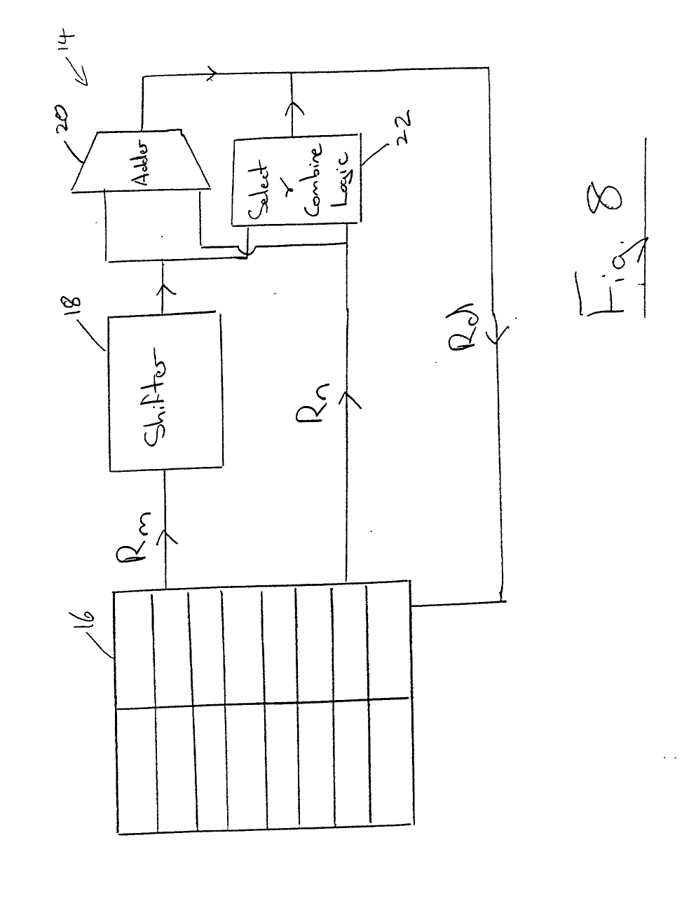

FIGS. 6 and 7 illustrate two variants of a half word packing SIMD type instruction. The PKHTB instruction of FIG. 6 takes a fixed top half of one input operand data word stored in register Rn and a variable position half bit portion of a second input operand data word stored in register Rm and combines these into respectively the top half and the bottom half of an output data word to be stored in register Rd. The instruction PKHBT takes the bottom half of an input operand data word of Rn and a variable position half word length portion of a second input operand data word of Rm and combines these respectively into the bottom and top halves of an output data word of Rd. It will be seen that the selected portion of the input operand data word of Rn in either case is unshifted in its location within the output data word Rd. This allows this portion to be provided by a simple masking or selecting circuit representing very little additional hardware overhead. The variable position half word portion of the instruction of FIG. 6 is selected from bit positions 15 to 0 of the word of Rm after that word has been right shifted by k bit positions. Similarly, the half word length variable position portion of Rm selected in accordance with the instruction of FIG. 7 is selected from bit positions 31 to 16 of the word of Rm after that word has been left shifted by k bit positions.

The variable shifting provided in combination with the packing function of the instructions of FIG. 6 and FIG. 7 is particularly useful for adjusting changes in the “Q” value of fixed point arithmetic values that can occur during manipulation of those values.

FIG. 8 illustrates a data path 14 that is particularly well suited for performing the instructions of FIGS. 3 and 4. A register bank 16 again provides the input operand data words, being 32-bit data words in this example, and stores the output data word. The data path includes a shifting circuit 18, an adder circuit 20 and a selecting and combining circuit 22.

In operation, the unshifted input operand data word of Rn passes directly from the register bank 16 to the selecting and combining logic 22. In the case of instruction of FIG. 6, the most significant 16 bits of the value of Rn are selected and form the corresponding bits within the output data word Rd. In the case of the instruction of FIG. 7 it is the least significant 16 bits of the input operand data word of Rn that are selected and passed to form the least significant bits of the output data word Rd. The input operand data word of Rm passes through the full shifting circuit 18. In the case of the instruction of FIG. 6, an arithmetic right shift of k bit positions in applied and then the least significant 16 bits from the output of the shifting circuit 18 are selected by the selecting and combining circuit 22 to form the least significant 16 bits of the output data word of Rd. In the case of the instruction of FIG. 7, the shifting circuit 18 provides a left logical shift of k bit positions and supplies the result to the selecting and combining circuit 22. The selecting and combining circuit 22 selects the most significant 16 bits of the output of the shifting circuit 18 and uses these to form the most significant 16 bits of the output data word of Rd.

It will be seen that the selecting and combining circuit 22 is provided in a position in parallel with the adder circuit 20. Accordingly, given that the data path 14 is carefully designed to allow for a full shift and add operation to be performed within a processing cycle, the relatively straight forward operation of selecting and combining can be provided within the time period normally allowed for the operation of the adder circuit 20 without imposing any processing cycle constraints.

One example area where the new SIMD type saturation instructions prove very useful is in computations performed in accordance with the MPEG4 standard, which requires many saturations to different precisions to be performed. The SIMD type saturation instructions work particularly well when combined with the above mentioned pack and arithmetic instructions. For an illustration of how these instructions work together, consider the motion compensation part of an MPEG decode operation. After the Inverse Discrete Cosine Transform (IDCT), a 16-bit difference value “d” is produced, and this value must then be saturated to a 9-bit signed value, and then added to an 8-bit unsigned value “m” representing the motion estimated value of the pixel. The result must then be saturated to an 8-bit unsigned pixel “p” representing the pixel value of the new frame. Hence:

d=signed IDCT output

m=unsigned motion predicted pixel

p=unsigned result pixel

p=unsigned-sat-8-bits (m+signed-sat-9-bits(d))

In typical implementations the m values are stored as an array of bytes starting at a word address, the p values similarly and the d values as an array of 16-bit values starting at a word address. Pictorially:

Motion predicted image (8×8 byte block):

m00 m01 m02 m03 m04 m05 m06 m07

m10 m11 m12 . . .

. . .

Added to the IDCT difference information (8×8 signed 16-bit values):

d00 d01 d02 d03 d04 d05 d06 d07

d10 d11 d12 . . .

. . .

Written as the pixel result (8×8 byte block):

p00 p01 p02 p03 p04 p05 p06 p07

p10 p11 p12 . . .

. . .

A standard implementation of the above operation would be of the form:

| | |
|---|---|
| LDRSH d, [d_address], #2 | ; load one signed d value |
| SSAT d, #9-bits | ; signed saturate d to 9 bits |
| LDRB m, [m_address], #1 | ; load one unsigned m value |
| ADD p, d, m | ; accumulate |
| USAT p, #8-bits | ; saturate p to 8-bits unsigned |
| STRB p, [p_address], #1 | ; store the resultant pixel |

In the above instruction list, the first load instruction loads one 16-bit d value into the destination register d and then increments a pointer by 2 bytes. A non-SIMD saturation instruction is then used to saturate d to 9 bits. Then, an 8-bit m value is loaded into a destination register m, with a pointer being incremented by 1 byte, followed by an add instruction to add d and m together, placing the result in a register p.

Next, a non-SIMD saturate instruction is used to saturate p to 8 bits, with the resulting pixel then being stored.

It is clear that this process requires six operations per pixel.

However if a SIMD saturation instructions is available in combination with the pack and arithmetic instructions PKHxx, ADD8TO16 then this operation can be accelerated as follows:

| | |
|---|---|
| LDR d01, [d_address], #4 | ; load d values 0,1 |
| LDR d23, [d_address], #4 | ; load d values 2,3 |
| PKHBT d02, d01, d23, | ; pack d values 0,2 |
| LSL#16 | |
| PKHTB d13, d23, d01, | ; pack d values 1,3 |
| ASR#16 | |
| SSAT16 d02, #9-bits | ; saturate d values 0 and 2 to 9-bits |
| SSAT16 d13, #9-bits | ; saturated d values 1 and 3 to 9-bits |
| LDR m, [m_address], #4 | ; load m values 0,1,2,3 |
| UADD8TO16 p02, d02, m | ; extract m values 0,2 and add to d vals |
| | 0,2 |
| UADD8TO16 p13, d13, m, | ; extract m values 1,3 and add to d vals |
| ROR #8 | 1,3 |
| USAT16 p02, #8-bits | ; saturate p values 0,2 to 8 bits |
| USAT16 p13, #8-bits | ; saturate p values 1,3 to 8 bits |
| ORR p, p02, p13, LSL#8 | ; combine to get p values 0,1,2,3 |
| STR p, [p_address], #4 | ; store the resultant 4 pixels |

As can be seen from the above instructions, the first two load instructions each load two 16-bit d values into destination register d01 and d23, respectively. A PKHBT pack instruction is then used to pack the bottom half of d01 with the top half of a shifted d23, this resulting in data values 0 and 2 being present in the destination register d02. Similarly, the pack instruction PKHTB loads the top half of d23 with the bottom half of the shifted version of d01, thereby storing data values 1 and 3 in the destination register d13. Two SIMD type saturate instructions SSAT16 are then executed to saturate values 0 and 2 and values 1 and 3 to 9-bits.

The load instruction is then used to load four 8-bit m values into a destination register m. Then an arithmetic instruction UADD8TO16 extracts m values 0 and 2 and adds them to d values 0 and 2. Similarly a further UADD8TO16 instruction extracts m values 1 and 3 and adds them to d values 1 and 3. Two SIMD type saturate instructions USAT16 are then used to saturate the resulting p values 0, 2 to 8 bits and p values 1, 3 to 8 bits.

This is followed by an ORR instruction used to combine together the p values 0, 1, 2 and 3, with the resulting from four pixels then being stored.

It will be appreciated that the above set of instructions requires thirteen operations, but results in four pixels being processed, and accordingly only 3.25 (13÷4) operations are required per pixel, almost twice as fast as the earlier mentioned technique which did not use the SIMD type saturation instructions of preferred embodiments in combination with the pack and arithmetic instructions.

It will be appreciated that the saturation circuitry of FIG. 3A could be positioned at any appropriate point within the data processing paths illustrated in FIGS. 5 and 8. However, in preferred embodiments, it is envisaged that the saturation circuitry would be located in parallel with the adder 8,20.

Although a particular embodiment has been described herein, it will be appreciated that the invention is not limited thereto and that many modifications and additions thereto may be made within the scope of the invention. For example, various combinations of the features of the following dependent claims can be made with the features of the independent claims without departing from the scope of the present invention.

We claim:

1. A data processing apparatus, comprising:
a data processing unit for executing instructions;
the data processing unit being responsive to a saturation instruction to apply a saturation operation to a data word Rm comprising a plurality of data values, wherein said saturation operation yields a value given by:
determining from data provided within a field of the saturation instruction a bit position to which saturation is to take place; and
performing in parallel an independent saturation operation on each of the data values to saturate each of the data values to the determined bit position to form a result data word Rd comprising a plurality of saturated data values.

2. A data processing apparatus as claimed in claim 1, wherein the specified bit position is the same for each of the plurality of data values.

3. A data processing apparatus as claimed in claim 1, further comprising a source register for storing the data word Rm, and a destination register for storing the result data word Rd.

4. A data processing apparatus as claimed in claim 1, wherein the data processing unit is arranged on completion of the saturation operation to set a flag if any of the data values were outside of the range of an ‘n’ bit number corresponding to the determined bit position.

5. A data processing apparatus as claimed in claim 1, wherein the saturation instruction comprises a signed saturation instruction and the plurality of saturated data values to be produced are signed data values.

6. A data processing apparatus as claimed in claim 1, wherein the saturation instruction comprises an unsigned saturation instruction and the plurality of saturated data values to be produced are unsigned data values.

7. A data processing apparatus as claimed in claim 1, wherein the saturation instruction is used in combination with a pack instruction to enable operations to be applied in parallel to selected data values.

8. A data processing apparatus as claimed in claim 7, wherein the data processing unit is arranged prior to execution of the saturation instruction to be responsive to the pack instruction to perform an operation on a first data word and a second data word, both the first and second data words comprising a number of data values, wherein the operation yields a value given by:
selecting a first data value of said first data word extending from one end of said first data word;
selecting a second data value of said second data word starting from a bit position specified as a shift operand within the pack instruction; and
combining the first and second data values to form respective different data values of said data word Rm.

9. A data processing apparatus as claimed in claim 1, wherein the saturation instruction is used in combination with an arithmetic instruction to enable operations to be applied in parallel to selected data values.

10. A data processing apparatus as claimed in claim 9, wherein the data processing unit is arranged prior to execution of the saturation instruction to be responsive to the arithmetic instruction to perform an operation on a first data word and a second data word, wherein the operation yields a value given by:
selecting a plurality of non-adjacent multibit portions of said first data word to form a plurality of multibit portions each of bit length A;
optionally shifting said plurality of multibit portions by a common shift amount to shifted bit positions;
promoting each of said plurality of multibit portions from said bit length of A to a bit length of B to form a plurality of promoted multibit portions, such that said promoted multibit portions may be abutted to form a promoted data word P; and
performing a plurality of independent arithmetic operations using as input operands respective bit position portions of bit length B from both said promoted data word P and said second data word to form said data word Rm comprising a plurality of data values of bit length B.

11. A data processing apparatus as claimed in claim 1, wherein the data word Rm comprises in a first mode of operation said plurality of data values and in a second mode of operation a single data value, and said data processing unit comprises:
a plurality of logic circuits corresponding to the plurality of data values within the data word Rm in the first mode of operation, each logic circuit being arranged to perform the independent saturation operation on the corresponding data value; and
coupling logic arranged, in said second mode of operation, to cause the plurality of logic circuits to operate together to saturate the single data value.

12. A data processing apparatus as claimed in claim 11, wherein each logic circuit comprises a selector for selecting the corresponding data value if that corresponding data value is within the range of an ‘n’ bit number corresponding to the determined bit position, or a mask value if that corresponding data value is outside of the range of the ‘n’ bit number, the mask value being dependent on the determined bit position.

13. A data processing apparatus as claimed in claim 12, wherein the coupling logic is arranged to be activated in the second mode of operation such that, if a particular logic circuit determines that the mask value should be selected, the coupling logic is arranged to cause each logic circuit processing less significant bits of the data value to select the mask value.

14. A data processing apparatus as claimed in claim 11, wherein the mode of operation is indicated by a signal received by the coupling logic and derived from the instruction being executed by the data processing unit.

15. A method of operating a data processing apparatus comprising a data processing unit for executing instructions, the method comprising the steps of:
in response to a saturation instruction, causing the data processing unit to apply a saturation operation to a data word Rm comprising a plurality of data values, wherein said saturation operation yields a value given by:
determining from data provided within a field of the saturation instruction a bit position to which saturation is to take place; and
performing in parallel an independent saturation operation on each of the data values to saturate each of the data values to the determined bit position to form a result data word Rd comprising a plurality of saturated data values.

16. A computer program operable to configure a data processing apparatus to perform a method as claimed in claim 15.

17. A carrier medium comprising a computer program as claimed in claim 16.
